(19) United States
(12) Patent Application Publication
(10) Pub. No.: US 2026/0021924 A1
(43) Pub. Date: Jan. 22, 2026

(54) DISCHARGE DEVICE AND METHOD FOR DISCHARGING WASTE MATERIAL

(71) Applicant: TT Innovation AG, Zug (CH)

(72) Inventors: Mathieu MÜLLER, Sierentz (FR); Mike ZELLER, Wahlen (CH)

(73) Assignee: TT Innovation AG, Zug (CH)

(21) Appl. No.: 19/276,176

(22) Filed: Jul. 22, 2025

(30) Foreign Application Priority Data
Jul. 22, 2024 (EP) 24190125.5

(51) Int. Cl. B65B 69/00; B09B 3/30; B09B 101/65

(52) U.S. Cl. CPC B65B 69/00; B09B 3/30; B09B 2101/65

(57) ABSTRACT

In the case of a discharge device (12) by which separable waste material can be brought out of a controlled environment (13), a transfer opening (20) is provided which outwardly separates a discard region (18) from a withdrawal region (21) for the path of the waste material (19) be closable during operation by a closure element (25), in particular in order to collect the waste material (19) in a stack arrangement.

### CROSS-REFERENCE TO RELATED APPLICATIONS

This application claims priority from European Patent Application No. 24190125.5. filed Jul. 22, 2024, which is incorporated herein by reference as if fully set forth.

### TECHNICAL FIELD

The invention relates to a discharge device having a controlled environment, at least one processing station being disposed within the controlled environment, a discard region for waste material separated by the processing station being formed, a withdrawal region being formed outside the controlled environment, a transfer opening for the waste material being formed between the discard region and the withdrawal region.

The invention further relates to a method for discharging waste material which is separated in a controlled environment, the waste material being brought out of the controlled environment through a transfer opening.

### BACKGROUND

Controlled environments are known and are used, for example, as isolators, as restricted-access barrier systems (RABS), in particular an open RABS or closed RABS, as a glovebox and in general as containment.

Such controlled environments serve to provide defined environmental conditions in industrial manufacturing steps, in particular in relation to cleanliness of surfaces and/or of the air in which the particular method is to take place, and in relation to a gas composition and/or an absence of propagatable material or other material. This is imperative particularly, but not only, in the area of processing pharmaceutical products.

One example, which is even a preferred application for the presently considered matter, is that of filling vessels with a pharmaceutical preparation. To this end, the vessels and the pharmaceutical preparation, for example a preparation in powder or liquid form, are brought into the controlled environment for processing there under the exclusion of unwanted contaminants.

It has become standard here to introduce the vessels to be filled into the controlled environment in packed form under sterile conditions and to unpack said vessels in the controlled environment. This creates waste material which is separated from the package and must be disposed of.

For example, it is known to provide unfilled vessels in nests in so-called tubs, said tubs having been sealed with a cover, for example a cover made of Tyvek or some other semipermeable material, in order to close the thus formed package containing the vessels. When the vessels are unpacked, said cover becomes waste material, since said cover needs to be removed or separated in order to access the vessels.

It has become standard here to outwardly convey these separated waste materials through slit openings which are permanently open in the process and which are formed in a boundary of the controlled environment.

### SUMMARY

It is an object of the invention to improve the process of unpacking.

Here, the invention achieves the object by providing, in the case of a discharge device, the combination of one or more of the features disclosed herein. In particular, the invention thus achieves the aforementioned object by proposing, in the case of a discharge device of the type described at the beginning, that the withdrawal region be formed in an additional controlled environment and that the transfer opening be closable. Any negative repercussion from the withdrawal region in the region of the controlled environment in which the sensitive manufacturing processes are taking place can thus be substantially precluded. The advantage of forming the withdrawal region in an additional controlled environment is that the environmental conditions can be still further controlled even after the waste material has been output from the controlled environment. This helps to avoid back-contamination through the transfer opening. The advantage of the closability of the transfer opening is that the additional controlled environment, i.e., for example an antechamber, can be provided in a simple manner, in particular by decontamination without any action having to occur on the controlled environment, i.e., for example a working chamber. For example, a process can proceed in the working chamber without being disturbed by the decontamination in the additional controlled environment.

This simplifies the process of unpacking, since the waste material can be brought out of the controlled environment in a way that substantially precludes any repercussion on or contamination of the controlled environment.

The waste material may be, for example, characterizable in that it is branched off during processing from a main branch of a material flow that can lead in particular to a finished product or an intermediate product. This does not preclude subsequent further use for other purposes. A nonexhaustive list of examples of waste material includes, for example, packaging material, interlayers, cuttings (which are possibly formed during unpacking), bags, films, Tyvek films, tools, monitoring equipment and sampling parts (for checking or documenting a batch).

The controlled environment may be, for example, an isolator. Other controlled environments may be, for example, sealed or sealable chambers, including containments or RABS, for example an open RABS or closed RABS, or gloveboxes.

In one embodiment of the invention, the processing station may be designed for separating waste material having three spatial dimensions in each case, a contour of the transfer opening being matched to two largest dimensions of the waste material. This makes it possible, for example, for the waste material, if it is substantially two-dimensional, to be transported through the transfer opening as quickly as possible. This also helps to minimize contact and thus exchange between the controlled environment and the additional controlled environment.

In one embodiment of the invention, a smallest dimension of the waste material may be a fraction of a minimum clear width of the transfer opening. The invention makes use of the fact that the cross-sectional area of a transfer opening can be comparatively large, since an additional controlled environment is downstream of the transfer opening and, in addition, the transfer opening is closable.

It is particularly beneficial if the minimum clear width is at least two hundred times, preferably at least five hundred times, the smallest dimension of the waste material. Planar waste materials in stacked form can thus be output through the transfer opening in a simple manner.

In one embodiment of the invention, the discard region may be delimited by a collection basket. Collecting the waste material, in particular within a delimited region, is thus simple to carry out. This facilitates outputting of the collected waste materials through the transfer opening. Preferably, the collection basket is downwardly open, which allows emptying through the effect of gravitational force.

In one embodiment of the invention, the collection basket may have at least one lateral opening. The advantage of this is that an aerial jam among waste materials discarded one above the other is preventable, and that an already existing laminar air flow or general air flow in the controlled environment is also usable for conveying the waste materials into the collection basket, for example by pushing the waste material into the collection basket.

A collection basket may be characterized, for example, as a device which delimits spreading of discarded material at least transversely to a discard direction.

In one embodiment of the invention, the waste material may be a tight (e.g., gas-tight) and/or semipermeable film that has been separated from a tub. The processing of tubs sealed with a semipermeable film, for example a Tyvek film, is a preferred application of the invention described. It is standard to process such tubs by pulling off or cutting out the (semipermeable/gas-tight/other) film. The separated film is then an example of the aforementioned waste material. Preferably, the semipermeable film is impervious to microorganisms and pervious to gaseous and/or atomized hydrogen peroxide or other gases.

The invention is particularly suitable for use in the processing of stackable waste material, in particular planar objects, as also provided by the described film by way of example.

In one embodiment of the invention, the controlled environment may have a closable entry at which a package closed by the waste material is presentable from the outside. This makes it possible to deliver an interior of the package, in particular a nest comprising (unfilled and/or open) pharmaceutical vessels such as vials, syringes, cartridges and the like, into the controlled environment in a way that is highly space saving and in particular does without an additional lock, the material delivered into the controlled environment being kept to a minimum. In particular, it is thus not necessary to deliver the entire tub or entire package into the controlled environment.

Typically, waste material is produced here, in particular the aforementioned films if tubs are processed as a vessel part.

Alternatively or additionally, the invention achieves the aforementioned object by providing further ones of the features disclosed herein. In particular, the invention thus achieves the object by providing, in the case of a discharge device of the type described at the beginning, that the withdrawal region be disposed within the region of action of a decontamination device. Contamination of the withdrawal region while outwardly emptying the withdrawal region can thus be eliminated in a simple manner. What can thus be realized is a two-stage discharge process in which the waste material is passed through the transfer opening into the withdrawal region first of all and passed outward from there, it being possible to restore the use state of the withdrawal region after discharge has been completed.

This embodiment is also combinable with the embodiments described above. This allows simple restoration of defined environmental conditions in the withdrawal region irrespective of the controlled environment.

Here, it may be beneficial if the withdrawal region is formed in an additional controlled environment, for example the additional controlled environment already described. The advantage of this is that a decontamination device can decontaminate the withdrawal region without other environmental regions being affected.

Here, the additional controlled environment may be definable irrespective of the aforementioned controlled environment. Different cleanliness classes, different pressure conditions or different flow conditions or other environmental parameters may be chosen here. After the transfer opening or closure element has been opened, the parameters/cleanliness classes can be the same in the two controlled environments now merged to form one space.

In one embodiment of the invention, the decontamination device may be activatable when the transfer opening is closed. An adverse effect on the original controlled environment when carrying out decontamination can thus be prevented in a simple manner, since the decontamination can only be carried out when the transfer opening is closed. It is also conceivable, when carrying out an initial decontamination, for respective decontamination devices on the two sides of the transfer opening to be operated while the transfer opening is open.

In one embodiment of the invention, the decontamination device may be disabled when the transfer opening is open. This is another way of preventing decontamination being carried for the withdrawal region, said decontamination having an adverse effect on the controlled environment in the main region.

In one embodiment of the invention, the withdrawal region may be lower than the discard region. It is thus possible to achieve conveyance through the transfer opening on the basis of the action of gravitational force and thus without additional moving parts.

Alternatively or additionally, the withdrawal region may be downstream of the discard region in relation to a direction of air flow of the controlled environment. The air flow can thus be used to convey the waste material into the withdrawal region or through the transfer opening.

Here, in addition, the air flow may form a circulation that remains in front of the transfer opening while the transfer opening is closed, and the circulation may be enlarged when the transfer opening is opened.

In one embodiment of the invention, the withdrawal region may be accessible from the outside through a closable opening. This makes it possible to outwardly protect the withdrawal region, so that unwanted contamination does not enter the withdrawal region. The withdrawal region can thus be cleaned or decontaminated without the environment being adversely affected.

It is most beneficial here if the opening is airtightly closable. This is a simple way of preventing decontaminants from escaping.

In one embodiment of the invention, the processing station may have a tool for separating the waste material. Automatic processing is thus made possible without any need for manual intervention. In particular, said tool may have a cutter. This allows separation of the waste material by cutting. Alternatively or additionally, said tool may have a gripper. This allows separation of the waste material by pulling it off.

Preferably, here, the waste material is the cover of a package, for example that of a tub-shaped vessel, in particular that of the aforementioned tub.

In one embodiment of the invention, the discard region can accommodate and/or stockpile multiple pieces of waste materials. This makes it possible to open the transfer opening as infrequently as possible, in order to preclude here any repercussion on the controlled environment as far as possible, and to run the decontamination process in the additional controlled environment only infrequently, since decontamination can be time-consuming.

In a further embodiment, a preferably closable waste air device may be present in the additional controlled environment. It may have a filter, for example a filter cartridge. This allows, for example, pressure control in the controlled environment and/or can (therefore) be used for creating defined flow conditions at the transfer opening.

This collected export of waste materials is particularly beneficial if the waste materials are planar and can thus be stacked easily.

In one embodiment of the invention, a main branch of the material flow may be defined and at least one of the following features, in particular two or more or all of the following features, may be formed in the main branch:
at least one magnetically levitatable transport unit is disposed in the controlled environment,
at least one filling station is disposed in the controlled environment,
at least one decontamination device for decontaminating at least parts of the waste material before separation is formed,
the main branch is designed for carrying out a pharmaceutical process, preferably for filling a vessel.

The discharge device according to the invention is thus usable in a pharmaceutical process. The advantage of using a magnetically levitatable transport unit (as part of a planar motor, for example the “Xplanar” system by Beckhoff Automation GmbH & Co. KG from Verl in Germany or the “ctrlX FLOW^{6D}” system by Bosch Rexroth AG from Lohr am Main in Germany) is that as few particles as possible are whirled up or generated during transport. This is advantageously useful for the discharge according to the invention.

The advantage of using a filling station is that filling operations can be carried out. Here, the discharge device is advantageously usable for discharging waste material used to cover or pack vessels to be filled.

The advantage of using a decontamination device for decontaminating at least parts of the waste material before separation is that the waste material is usable before separation as the outer packaging of the articles to be protected and to be processed in the controlled environment. For example, the decontamination device may be configured for decontamination by means of high-energy radiation, in particular UVC radiation and/or other electromagnetic and/or electron radiation (e.g., E-beam). The advantage of this irradiation is, inter alia, that it is rapid and/or there are minimal residues from the decontamination operation remaining on the waste material. As a result, the waste material is simpler to process.

Generally speaking, the invention is readily usable in a pharmaceutical process, for example processing of pharmaceutical vessels, in particular filling said vessels in a controlled environment, with reduction or complete elimination of manual interventions. As result, the error rate in production can be reduced.

In one embodiment of the invention, the processing station may have a gripper with a variable gripping width. The advantage of this is that the gripper can be used for successively carrying out different processing steps, in particular different separation steps for multiple waste materials. For example, a sealed cover can thus be removed, followed by an additional cover underneath in the form of an insert sheet. In addition, it is thus possible to use the gripper to carry out subsequent processing steps as well, such as withdrawing a nest or withdrawing vessels from the nest.

It is particularly beneficial if the variable gripping width is achieved by relative movement of at least two gripping points in relation to each other. A mechanically simple-to-handle solution is thus created.

Alternatively or additionally, the processing station may have a vacuum unit for generating vacuum at a gripper, for example the aforementioned gripper. This type of gripping by means of vacuum is particularly beneficial for planar waste materials. Uncontrolled folding or bending of the waste material, which would hamper or hinder subsequent automated discharge, can thus be avoided. The vacuum unit may be, for example, a jointly moved vacuum unit or a stationary vacuum unit. The vacuum may be conveyed to the gripper via a hose or multiple hoses.

Alternatively or additionally, the invention achieves the stated object by providing the features of a method. In particular, the invention thus provides, in the case of a method of the type described at the beginning, that the waste material be collected ahead of the transfer opening and subsequently delivered out of the controlled environment. It is thus possible to minimize any repercussion, which can never be completely ruled out, at least theoretically, during transfer out of the controlled environment, by avoiding separate delivery of each waste material out of the controlled environment.

It is particularly beneficial here if the waste material is collected as a stack arrangement ahead of the transfer opening. The advantage of this is that, firstly, a stack arrangement has limited space requirements and, secondly, it allows proper further processing of planar waste material.

It is particularly beneficial if the collected waste material is jointly delivered out of the controlled environment. The advantage of this is that a length of time for discharge can be kept short.

It is particularly beneficial if the waste material is subsequently (following collection) delivered out of the controlled environment. The advantage of outputting the waste material after it has been collected is that the number of times required to open the transfer opening is kept to a minimum.

Alternatively or additionally, the invention achieves the stated object by providing features of a further method. In particular, the invention thus provides, in the case of a method of the type described at the beginning, that the transfer opening be closed between two consecutive discharges. This makes it simple to carry out decontamination or the like beyond the transfer opening following withdrawal of the discharged waste material, in order to restore the original state of the withdrawal region, without having to adversely affect the controlled environment.

It is particularly beneficial here if the transfer opening is automatically closed. This prevent individual errors due to manual processing from occurring.

In one embodiment of the invention, the waste material may be collected on a rest before it is delivered through the transfer opening. A space-saving way of collecting and, in particular, forming a stack arrangement is thus described. It is particularly beneficial if the rest on which collection occurs is a closure element of the transfer opening. The advantage of this is that further manipulation of the collected waste material is not necessary. Rather, this embodiment makes it possible to initiate output from the controlled environment by opening the closure element.

In one embodiment of the invention, the waste material may be delivered into a withdrawal region downstream of the transfer opening and outwardly taken from there, and the withdrawal region may be closed off from the controlled environment before the waste material is withdrawn. This makes it simple to reduce or completely preclude contamination of the controlled environment due to handling of the waste material in the withdrawal region. It is particularly beneficial here if the controlled environment is automatically closed before the waste material is withdrawn from the withdrawal region. This makes it possible to reduce operator errors.

In one embodiment of the invention, the withdrawal region may be decontaminated after the waste material has been withdrawn. Risks of contamination that might arise as a result of withdrawal of waste material from the withdrawal region can thus be eliminated in a simple manner. It is particularly beneficial if decontamination is carried out while the transfer opening is closed. Any adverse effect on the controlled environment by decontamination steps beyond the controlled environment (within the withdrawal region) can thus be reduced or completely precluded.

In one embodiment of the invention, the waste material may be separated from a package. It is thus possible to implement method steps or processing steps typical of filling operations or processing operations for pharmaceutical substances and pharmaceutical vessels.

It is particularly beneficial if the waste material is in the form of a cover and/or interlayer of a tub or in the form of contents, for example a nest. It is clear that the method according to the invention can be implemented at different substeps of a pharmaceutical process. For example, the stated package may be or comprise a tub. This opens up many applications in the filling of pharmaceutical vessels provided in (sealed) tubs.

In one embodiment of the invention, the waste material may be separated in an automated manner. This helps to reduce or even completely avoid manual processing operations in the controlled environment, though manual separation may also occur, for example by way of interventions with gloves in glove ports.

For example, this automated separation may be carried out by a robotic or handling system. Relatively complex processing steps can thus be realized without manual intervention and at high frequencies.

In one embodiment of the invention, during outputting of the waste material, the closure element may be first closed and a door of a withdrawal region, in particular the aforementioned withdrawal region, may be then opened. A lock function can thus be realized.

It is particularly beneficial if the door is outwardly opened. In this way, any contamination through the transfer opening can be kept particularly low. Outward opening of the transfer opening has the additional advantage that collisions between a closure element and the collected waste material in a stack arrangement can be avoided. This helps to save space in the controlled environment.

In one embodiment of the invention, at least one, in particular two or more or all, of the following steps may be carried out between removing the waste material and withdrawing the waste material from the withdrawal region
a. gripping the waste material at least during separation,
b. moving the waste material to the discard region, in particular to a collection basket, for example the aforementioned collection basket, preferably by means of a robotic or handling unit,
c. allowing storage, preferably in a collection basket, for example the aforementioned collection basket, preferably in the discard region,
d. opening, preferably outwardly, a closure element that closes the transfer opening,
e. allowing vertical passage through a temporarily opened closure element of the transfer opening,
f. closing the closure element,
g. opening, preferably outwardly, a door, for example the aforementioned door, that outwardly closes off the withdrawal region (e.g., for withdrawal of the waste material from the withdrawal region)
h. decontaminating an exterior of the transfer opening (preferably after closing the door from step g.).

Here, individual steps may be omitted or be carried out in a modified order in further embodiments.

Here, moving the waste material to the discard region allows the processing region at the processing station to be cleared as quickly as possible.

The advantage of storage of the waste material in a collection basket, for example the aforementioned collection basket, which can define for example the discard region is that a stack arrangement of the waste material can be formed in a simple manner.

The advantage of vertical passage at the transfer opening is that transfer or discharge can be brought about through the action of gravitational force.

Here, for example, the closure element may be open only temporarily. This makes it possible to define closure times of the transfer opening, in which associated method steps can be carried out. One process step may be that of decontaminating the withdrawal region. The advantage of closing the closure element is that action by a process step from the withdrawal region in the controlled environment can be avoided. Here, it is particularly beneficial if the withdrawal region is disposed in an additional controlled environment.

The advantage of outwardly opening, in relation to the controlled environment, a closure element that closes the transfer opening is that recontamination due to inwardly pivoting closure elements can be avoided. In addition, the space requirements of the discharge device inside the controlled environment can thus be reduced, especially since the closure element does not then need to avoid the stacked waste material. However, depending on the division of space in the controlled environment, it may also be beneficial if the closure element can be inwardly opened into the controlled environment.

The advantage of outwardly opening a door that outwardly closes off the withdrawal region is that the withdrawal region can be designed as freely as possible. This facilitates re-decontamination of the withdrawal region after the waste material has been withdrawn.

The advantage of decontaminating an exterior of the transfer opening (and thus, for example, of the closure element as well) is that the withdrawal region can thus be decontaminated in a simple manner without any possible adverse effect on the controlled environment, in which preparations react sensitively to the decontamination method.

In one embodiment of the invention, a main branch of a material flow may be conveyed by means of at least one magnetically levitated transport unit (e.g., as described above). The invention makes use of the fact that the majority of process steps can be realized with a magnetically levitatable transport unit in the controlled environment. This reduces the input of particles that may result from moving parts during necessary transport.

In one embodiment of the invention, at least one filling station may be approached in a main branch, for example the aforementioned main branch, of a material flow. The invention can thus be particularly preferably realized in the area of pharmaceutical filling of vessels.

In one embodiment of the invention, the waste material may be decontaminated, in particular by high-energy radiation such as UVC radiation, before separation in a main branch of the material flow, for example the aforementioned main branch. The advantage of this is that at least a portion of a package can remain outside the controlled environment and does not have to be inwardly transferred with outer packaging (e.g., a bag). The invention has recognized that it is possible to introduce only a portion of the package into the controlled environment by decontaminating (only) said portion (here: the cover for example) before it is opened in the controlled environment.

In one embodiment of the invention of possibly independent inventive quality, in the case of a method of the type described at the beginning or in the case of one of the preceding embodiments, the waste material may be separated by means of a gripper and separation of the waste material in a main branch, for example the aforementioned main branch, of the material flow may be followed by the gripper carrying out a further gripping step with an altered gripping width. The advantage of this is that different format-based parts or different covers and waste materials nested in one another can be processed.

In one embodiment of the invention of possibly independent inventive quality, in the case of a method of the type described at the beginning or in the case of one of the preceding embodiments, a waste material may be separated and the waste material may be separated by means of a gripper, for example the aforementioned gripper, with a vacuum for gripping being generated by means of a vacuum unit. It is particularly beneficial if said vacuum unit is disposed for joint movement with the gripper, for example on the aforementioned handling unit or the aforementioned robot.

The advantage of separating the waste material by means of a gripper to which vacuum is applied is that a minimal number of moving parts are required in the controlled environment. Moreover, a gripper to which vacuum is applied provides minimal particle input due to gripping and is also suitable for difficult-to-grasp materials (e.g., in the case of materials that crease easily).

In one embodiment of the invention, a frequency of separation of the waste material may be greater than a frequency of discharge of the waste material. What is thus described is a method in which the discharge of the waste material produced can be chosen relatively flexibly. Collecting waste material before discharge can thus be done in a simple manner.

### BRIEF DESCRIPTION OF THE DRAWINGS

The invention will now be described in more detail on the basis of embodiments, but is not restricted thereto. Further exemplary embodiments will become apparent from combining the features of individual or multiple claims and/or with individual or multiple features of the exemplary embodiments.

In the drawings:

FIG. 1 shows an exploded view of a pharmaceutical container,

FIG. 2 shows a schematic longitudinal sectional view of the intact pharmaceutical container from FIG. 1,

FIG. 3 shows a schematic diagram of a controlled environment having a discharge device according to the invention,

FIG. 4 shows the arrangement according to FIG. 3 during a discharge operation for waste material,

FIG. 5 shows the withdrawal of the waste material from the withdrawal region in an arrangement according to FIG. 3,

FIG. 6 shows a further arrangement for realizing the invention with an illustration of the flow conditions,

FIG. 7 shows a further arrangement with an illustration of the material flow in the main branch, with the withdrawal region being decontaminated and waste materials being collected in the discard region, and of further stations of the main branch for processing in the controlled environment,

FIG. 8 shows the arrangement according to FIG. 7 after the transfer opening has been opened,

FIG. 9 shows a further arrangement for realizing the method according to the invention and the device according to the invention, the discharge being horizontally oriented,

FIG. 10 shows the arrangement according to FIG. 9 following discharge of the waste material and before said waste material has been withdrawn, and

FIG. 11 shows an example of a tool from one of the preceding figures.

### DETAILED DESCRIPTION

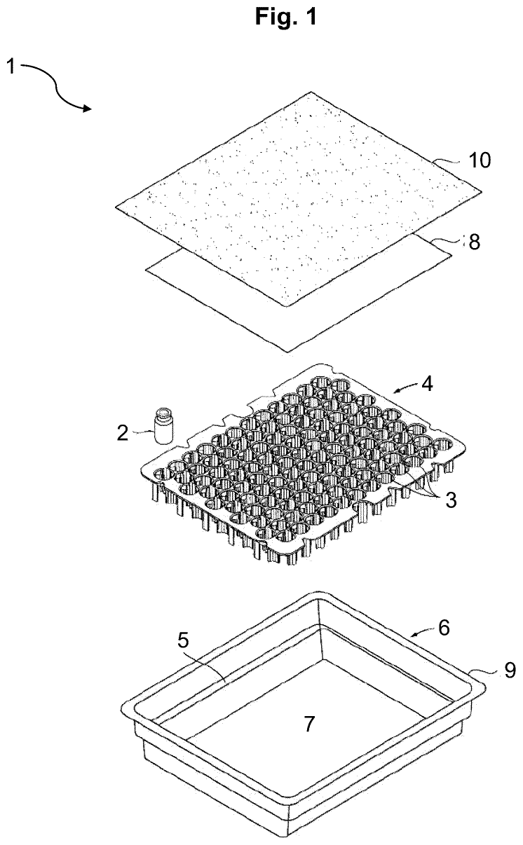

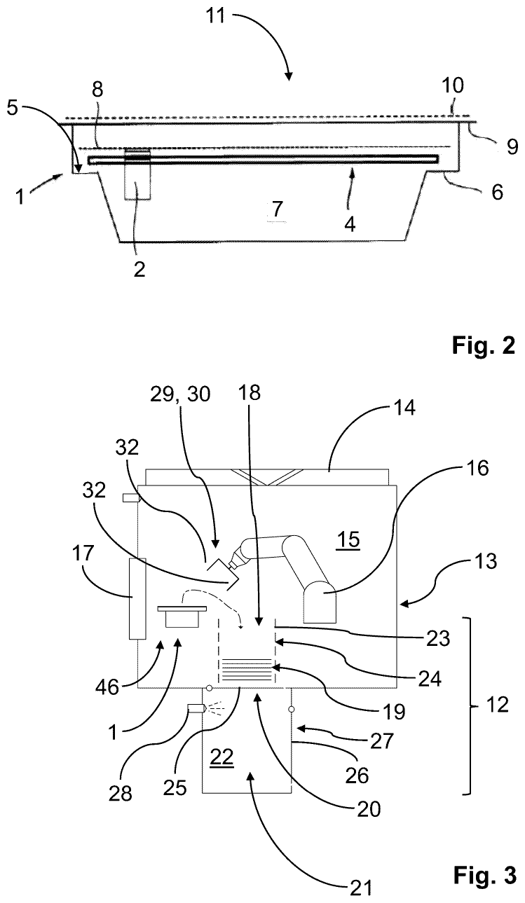

FIGS. 1 and 2 show different views of a container 1 containing pharmaceutical vessels 2, which are in the form of vials here by way of example.

The vessels 2 are unfilled and are arranged in slots 3 of a nest 4.

The nest 4 is inserted onto a support 5 of a tub 6 and occupies an interior 7.

An interlayer 8 is placed onto the inserted vessels 2, such that all vessels 2 are covered. Said interlayer 8 is made of a preferably nonwoven material, for example Tyvek or other nonwoven, for example a product of a flash-spinning method. The interlayer is especially impervious to microorganisms, but can be penetrated by vapor and especially gaseous and/or atomized hydrogen peroxide.

The tub 6 has a peripheral edge 9 to which a cover 10 is preferably integrally bonded.

Similarly or identically to the interlayer 8, the cover 10 is made of a semipermeable material, in particular a material which keeps microorganisms away, but allows the passage of decontaminants in gaseous and/or atomized form. Here too, preference is given to using a nonwoven, in particular the product Tyvek produced by DuPont in a flash-spinning method.

The tub 6 and the cover 10 thus form the package for the unfilled vessels 2.

In further exemplary embodiments, a gas-tight cover 10 is used.

FIGS. 3-5 show different operating states of a discharge device according to the invention, denoted as a whole by 12.

The discharge device 12 is part of a controlled environment 13. In the exemplary embodiment, the controlled environment 13 is shown as an isolator.

In other exemplary embodiments, the controlled environment 13 may be realized, for example, as an open RABS or closed RABS.

As is already known, the controlled environment 13 has an air supply 14 for generating a laminar flow 35 into an interior 15 of the controlled environment.

Disposed in the interior is a processing station 16 (here: a robotic or handling unit 45) by means of which pharmaceutical containers 1 (FIGS. 1 and 2) delivered into the controlled environment 13 through an entry 17 can be unpacked.

Here, the processing station 16 removes at least the cover 10 and optionally the interlayer 8 as well, and they are collected as separated waste material 19 in a discard region 18.

The discharge device 12 has a transfer opening 20 by means of which the waste material 19 can be brought out of the interior 15 of the controlled environment 13.

Downstream of the transfer opening 20 is a withdrawal region 21 into which the separated and collected waste material 19 passes after crossing the transfer opening 20.

Said withdrawal region 21 is formed in an additional controlled environment 22, for example an antechamber. Said additional controlled environment 22 is partitionable from the controlled environment 13, for example the working chamber, by the airtightly closable transfer opening 20 and is also outwardly partitioned, in particular airtightly closed for example, in order to set or maintain defined environmental conditions in the additional controlled environment 22.

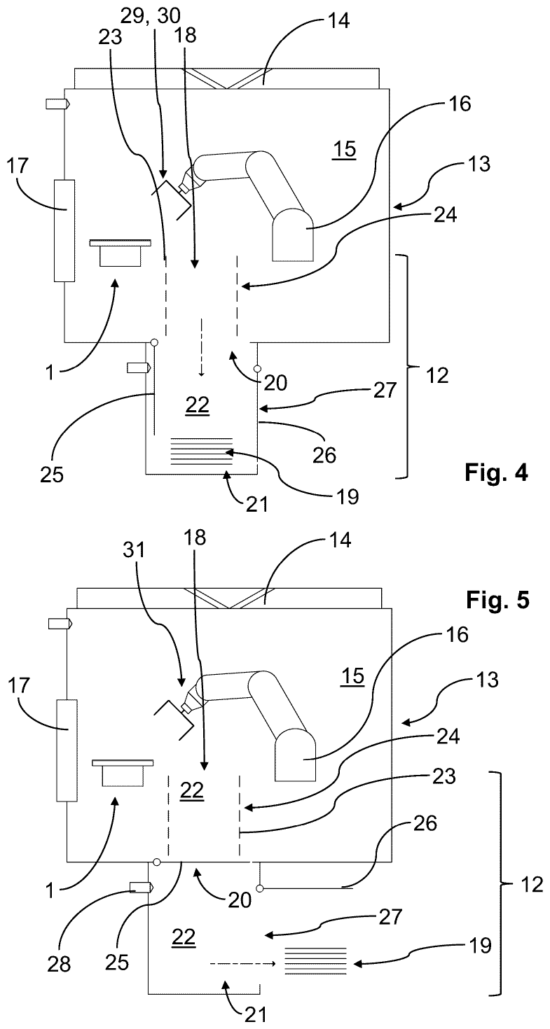

FIG. 4 shows that the transfer opening 20 can be opened, such that, in the open state, the waste material 19 is transferred from the discard region 18 to the withdrawal region 21.

It can be seen in FIG. 3 that the waste material 19 is planar and thus has two largest dimensions, which are the horizontal dimensions here and are matched to a contour of the transfer opening 20 in such a way that the waste material 19 fits through the transfer opening 20 without any deformation.

Here, the smallest dimension of each sheet of the waste material 19 is many times smaller than the clear width of the transfer opening 20, for example two hundred times smaller or five hundred times smaller.

The discard region 18 is delimited from the rest of the interior 15 by a collection basket 23. This allows the collection of the discarded waste materials 19 as a stack.

As can be seen from FIG. 4, said collection basket 23 is downwardly open.

Laterally, the collection basket 23 has a multiplicity of lateral openings 24 through which air can escape. This promotes the (controlled) dropping of the separated waste materials 19 onto the stack.

The discharge device 12 has a closure element 25 which is in the form of a pivotable flap here and which is outwardly pivotable, downwardly pivotable here, and forms a rest in the form of a bottom of the discard region 18 (and of the collection basket 23).

Once the closure element 25 opens, the collected stack of waste materials 19 drops downward into the withdrawal region 21.

In a further exemplary embodiment, the closure element 25 may also be movable, for example like a sliding door, or shape-changing, for example like an iris diaphragm.

Thereafter, the closure element 25 is reclosed (FIG. 5).

The additional controlled environment 22 has a door 26 which can be outwardly opened, as shown in FIG. 5.

When the door 26 is open, the waste material 19 can be outwardly withdrawn from the withdrawal region 21.

Here, the door 26 airtightly closes an opening 27 through which the withdrawal region 21 is accessible from the outside for withdrawal of the waste material 19.

Reclosing the door 26 results in the situation according to FIG. 3 once again.

Here, the additional controlled environment 22 may be provided with a decontamination device 28 by means of which the additional controlled environment 22 can be re-decontaminated after the waste material 19 has been withdrawn and before the transfer opening 20 is opened once again.

Here, the withdrawal region 21 is within the region of action of the decontamination device 28.

Here, the decontamination device is coupled to the closure element 25 and the door 26 in such a way that it is inactivatable when the closure element 25 is open and/or when the door 26 is open and that the function is disabled instead.

It can thus be ensured that the decontaminant of the decontamination device 28 does not accidentally pass through the opening 27 or the transfer opening 20.

The processing station 16 has a tool 29 by means of which the cover 10 can be opened and removed. To this end, the tool 29 has not only a cutter but also a gripper 30.

The gripper 30 serves not only for separation of the cover 10, but also for withdrawal of the interlayer 8.

To this end, the processing station 16 has a vacuum unit 31, which is not shown in further detail, by means of which suction cups for gripping the separated waste materials 19 are possible.

Separation of the waste materials and later withdrawal of vessels 2 from the tub 6 (cf. FIGS. 1 and 2) takes place in a processing region 46.

In relation to a direction of air flow defined at least by the air supply 14, the withdrawal region 21 is downstream of the discard region 18.

The stated gripper 30 has at least two gripping points 32 by means of which the above-described nest 4 can also be withdrawn. To this end, a gripping width can be set by relative movement of the gripping points 32 with respect to each other, since the nest 4 and/or the interlayer 8 must have dimensions different from the separated cover 10.

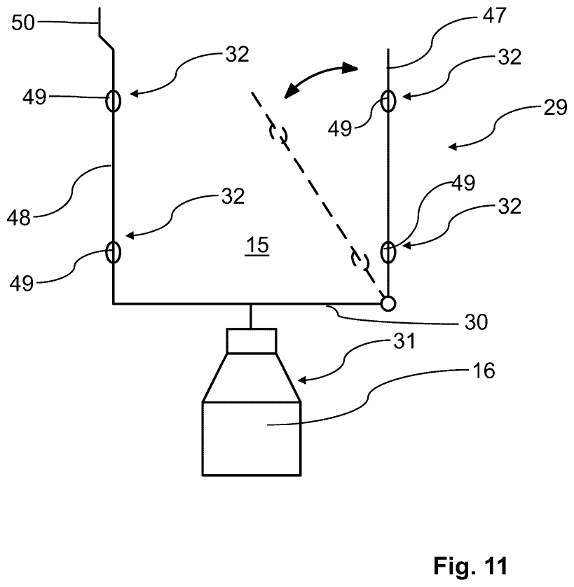

FIG. 11 shows the gripper 30 with the gripping points 32. A gripper arm 47 is movable, thereby allowing setting of the gripping width relative to the immovable gripper arm 48 by pivoting of the movable gripper arm 47.

Each gripper arm 47, 48 bears suction cups 49 which are connected to the vacuum unit 31 via hoses.

Disposed on the immovable gripper arm 48 is a cutter 50 by means of which the cover 10 can be cut out.

It can be further seen from the motion sequence in FIGS. 3-5 that the transfer opening 20 is closed before and after the outputting of the waste material 19 from the discard region 18 into the withdrawal region 21. This closing is done automatically and ensures that cross-contamination from the additional controlled environment 22 into the controlled environment 13 does not occur.

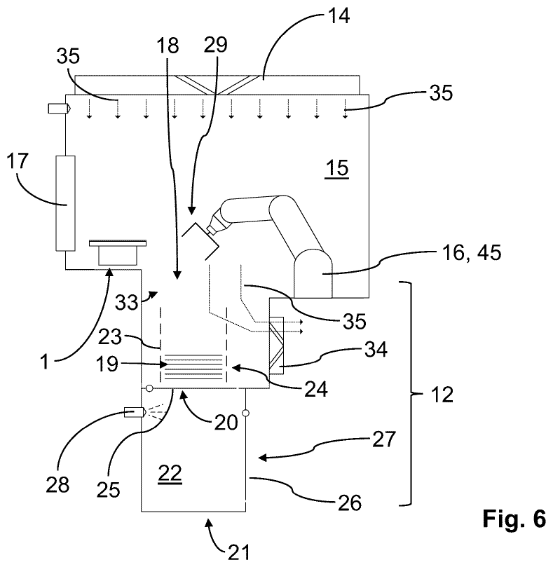

FIG. 6 shows a further exemplary embodiment according to the invention. Components and functional units which are similar or identical in structure and/or function to the preceding exemplary embodiments are denoted by the same reference signs and are not described again separately. The discussions in relation to the preceding exemplary embodiment therefore apply, mutatis mutandis, to FIG. 6.

The exemplary embodiment according to FIG. 6 differs from the preceding exemplary embodiment in that the discard region 18 is disposed in a hollow 33 provided with an air discharge 34. The air discharge 34 interacts with the air supply 14 in order to generate a defined laminar flow 35 which makes it impossible for the opened packages 11 to be contaminated by particles from the waste material 19.

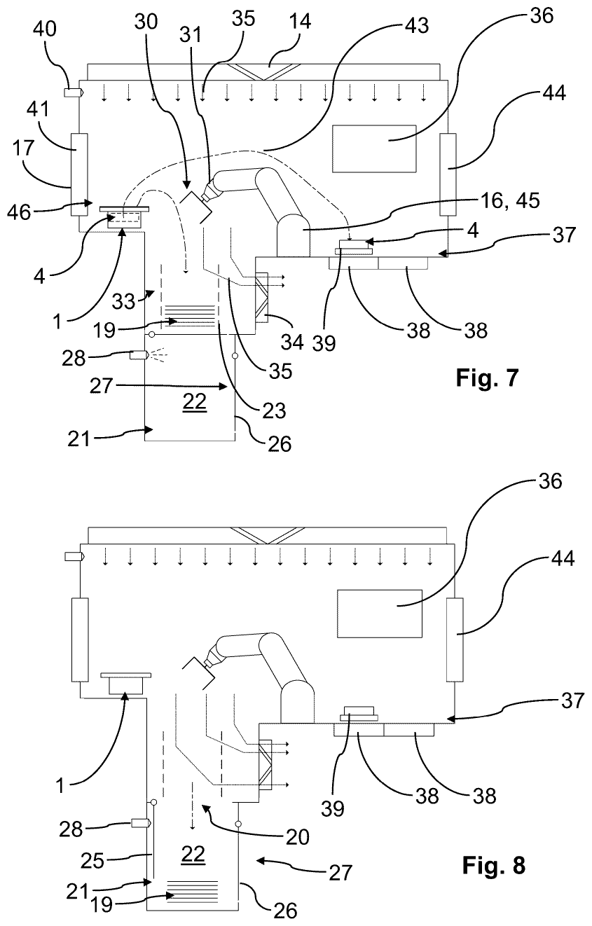

FIGS. 7 and 8 show a further exemplary embodiment according to the invention. Components and functional units which are similar or identical in structure and/or function to the preceding exemplary embodiments are denoted by the same reference signs and are not described again separately. The discussions in relation to the preceding exemplary embodiment therefore apply, mutatis mutandis, to FIGS. 7-8.

The exemplary embodiment according to FIGS. 7-8 further differs from the preceding exemplary embodiments in that a filling station 36 is shown in the interior 15 of the controlled environment 13.

FIGS. 7 and 8 also show the main branch 43 of processing of the pharmaceutical vessels 2.

The main branch 43 starts from the entry 17, goes past the filling station 36 and other processing stations not shown in further detail, such as a closing station, testing station, crimping station, labelling station and the like, and ends at the exit 44. Transport of the vessels 2, which are filled and closed and secured and labelled in this way, is provided by the transport system 37 comprising the transport units 39.

In addition, FIGS. 7-8 show a transport system 37 comprising magnetic field generators 38 which are disposed outside the controlled environment 13 and transport units (movers) 39 which are disposed inside the controlled environment 13 and which can be magnetically levitated by the magnetic field generators 38 and moved to and from the filling station 36 in a controlled manner.

The processing station 16 is configured such that the vessels 2 can be taken out of the tub 6 and placed onto the transport units 39. From there, they are further processed in the main branch 43.

The controlled environment 13, too, has a decontamination device 40, by means of which the interior 15 can be decontaminated.

In addition, the entry 17 is fitted with a decontamination device 41, the operation of which is also based on hydrogen peroxide, or is not based thereon, but on high-energy irradiation, for example UVC radiation, instead.

Said decontamination device 41 may be used to decontaminate the cover 10 on the package 11. In a further exemplary embodiment, the rest of the package (the tub) may remain docked at the entry 17 outside the controlled environment 13.

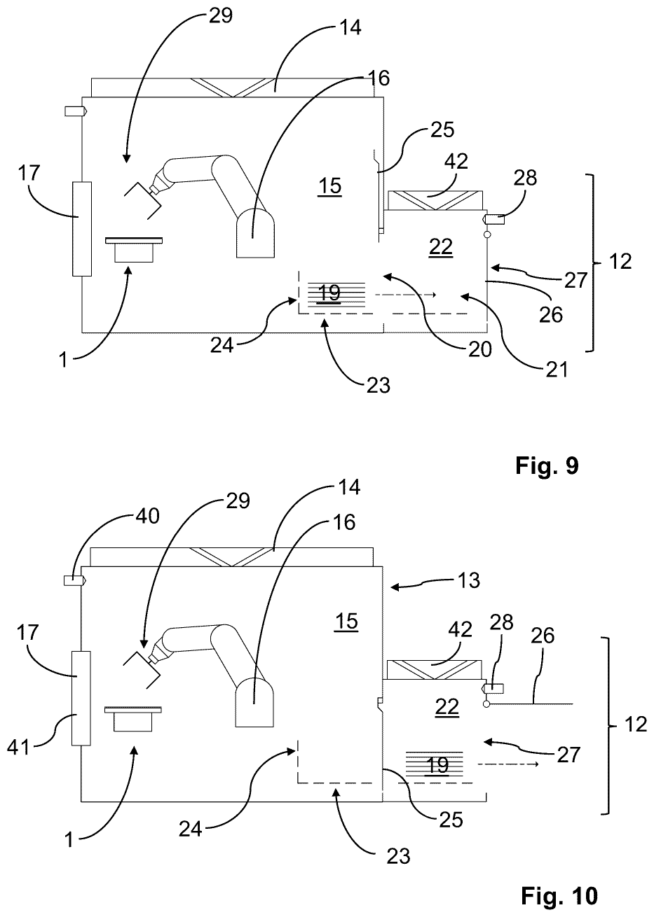

FIGS. 9 and 10 show a further exemplary embodiment of the invention in different operating positions. Similar or identical components and functional units are again denoted by the same reference signs and are not described again separately. The discussions in relation to the preceding exemplary embodiments therefore apply, mutatis mutandis, to FIGS. 9 and 10.

FIGS. 9 and 10 show the case in which the waste material 19 does not drop downward, but is instead delivered out of the controlled environment 13 in a horizontal direction. Here, the closure element 25 is in the form of a sliding door.

The additional controlled environment 22 may have a further air supply 42 of its own that defines the environmental parameters of the additional controlled environment 22.

In the case of a discharge device 12 by means of which separable waste material can be brought out of a controlled environment 13, the invention thus provides that a transfer opening 20 which outwardly separates a discard region 18 from a withdrawal region 21 for the path of the waste material 19 be closable during operation by a closure element 25, in particular in order to collect the waste material 19 in a stack arrangement.

### LIST OF REFERENCE SIGNS

1 container
2 vessel
3 slot
4 nest
5 support
6 tub
7 interior
8 interlayer
9 edge
10 cover
11 package
12 discharge device
13 controlled environment
14 air supply
15 interior
16 processing station
17 entry
18 discard region
19 waste material
20 transfer opening
21 withdrawal region
22 additional controlled environment
23 collection basket
24 opening
25 closure element
26 door
27 opening
28 decontamination device
29 tool
30 gripper
31 vacuum unit
32 gripping point
33 hollow
34 air discharge
35 laminar flow
36 filling station
37 transport system
38 magnetic field generator
39 transport unit
40 decontamination device
41 decontamination device
42 air supply
43 main branch
44 exit
45 robotic or handling system
46 processing region
47 (movable) gripper arm
48 (immovable) gripper arm
49 suction cup
50 cutter

1. A discharge device (12). Comprising:
a controlled environment (13);
a processing station (16) disposed within the controlled environment (13);
a discard region (18) for waste material (19) separated by the processing station (16);
a withdrawal region (21) formed outside the controlled environment (13);
a transfer opening (20) for the waste material (19) formed between the discard region (18) and the withdrawal region (21); and
the withdrawal region (21) is formed in an additional controlled environment (22) and the transfer opening (20) is closeable airtight.

2. The discharge device (12) as claimed in claim 1, wherein the processing station (16) is configured to separate waste material (19) having three spatial dimensions in each case, a contour of the transfer opening (20) being matched to two largest dimensions of the waste material (19) and/or a smallest dimension of the waste material (19) being a fraction of a minimum clear width of the transfer opening (20), the minimum clear width being at least 200 times the smallest dimension of the waste material (19).

3. The discharge device (12) as claimed in claim 2, wherein the discard region (18) is delimited by a collection basket (23) which is downwardly open and/or wherein the collection basket (23) has at least one lateral opening.

4. The discharge device (12) as claimed in claim 1, further comprising a closure element (25) for the transfer opening (20) that forms a rest of the discard region (18) and/or wherein the closure element (25) of the transfer opening (20) opens outwardly in relation to the controlled environment (13).

5. The discharge device (12) as claimed in claim 1, wherein the waste material (19) is a semipermeable film, which has been separated from a tub (6) and/or wherein the controlled environment (13) has a closable entry at which a package (11) closed by the waste material (19) is presentable from outside.

6. The discharge device (12) according to claim 1, wherein the withdrawal region (21) is disposed in a region of action of a decontamination device (28), the withdrawal region (21) being formed in the additional controlled environment (22) or a further controlled environment.

7. The discharge device (12) as claimed in claim 1, wherein the decontamination device (28) is activatable when the transfer opening (20) is closed and/or wherein the decontamination device (28) is disabled when the transfer opening (20) is open.

8. The discharge device (12) as claimed in claim 1, wherein the withdrawal region (21) is lower than the discard region (18), and/or wherein the withdrawal region (21) is downstream of the discard region (18) in relation to a direction of air flow of the controlled environment (13) and/or wherein the withdrawal region (21) is accessible from outside through an airtightly closable opening (24).

9. The discharge device (12) as claimed in claim 1, wherein the processing station (16) has a tool (29) for separating the waste material (19) from a package (11), and/or wherein the discard region (18) can accommodate and/or stockpile multiple pieces of waste materials (19).

10. The discharge device (12) as claimed in claim 1, wherein a main branch (43) of the material flow is defined and at least one of:
at least one magnetically levitatable transport unit (39),
at least one filling station (36), or
at least one decontamination device (41) for decontaminating at least parts of the waste material (19) before separation; and
the main branch (43) is adapted for carrying out a pharmaceutical process.

11. The discharge device (12) as claimed claim 1, wherein the processing station (16) has a gripper (30) with a variable gripping width and/or a vacuum unit (31) for generating vacuum at the gripper (30).

12. A method for discharging waste material (19) which is separated in a controlled environment (13) and delivering the waste material (19) out of the controlled environment (13) through a transfer opening (20), the method comprising:
collecting the waste material (19) ahead of the transfer opening (20); and
subsequently delivering the waste material (19) out of the controlled environment (13).

13. The method according to claim 12, further comprising:
automatically closing the transfer opening (20) between two consecutive discharges, and/or
collecting the waste material (19) on a rest (5) before it is delivered through the transfer opening (20), and/or
automatically closing off a withdrawal region (21) from the controlled environment (13) before the waste material (19) is withdrawn, the waste material (19) being delivered into the withdrawal region (21) downstream of the transfer opening (20).

14. The method as claimed in claim 12, further comprising delivering the waste material (19) into a withdrawal region (21) downstream of the transfer opening (20) and outwardly withdrawn from there, and decontaminating the withdrawal region (21) while the transfer opening (20) is closed, after the waste material (19) has been withdrawn.

15. The method as claimed in claim 12, further comprising separating the waste material (19) from a package (11), and during outputting of the waste material (19), first closing the closure element (25) and then opening a door of the or a withdrawal region (21).

16. The method as claimed in claim 12, wherein at least one of the following steps is/are carried out between removing the waste material (19) and withdrawing the waste material (19) from a withdrawal region (21):
a. gripping the waste material (19) at least during separation,
b. moving the waste material (19) to the discard region (18) via a robot or handling unit,
c. allowing storage in the discard region (18),
d. outwardly opening a closure element (25) that closes the transfer opening (20),
e. allowing vertical passage through a temporarily opened closure element (25) of the transfer opening (20),
f. closing the closure element (25),
g. outwardly opening a door that outwardly closes off the withdrawal region (21),
h. decontaminating an exterior of the transfer opening (20).

17. The method as claimed in claim 12, further comprising conveying a main branch (43) of a material flow by at least one magnetically levitated transport unit (39), and/or
approaching at least one filling station (36) in the main branch (43) of the material flow, and/or
decontaminating the waste material (19) before separation in the main branch (43) of the material flow.

18. The method according to claim 12, further comprising separating the waste material (19) via a gripper (30), and separation of the waste material (19) in a main branch (43) of a material flow is followed by the gripper (30) carrying out a further gripping step with an altered gripping width.

19. The method according to claim 12, further comprising separating the waste material (19) via a gripper (30), with a vacuum for gripping being generated by a vacuum unit (31).

20. The method as claimed in claim 12, further comprising delivering the waste material (19) out of the controlled environment (13) through the transfer opening (20) with two largest dimensions of the waste material transverse to a direction of transport and/or with a smallest dimension of the waste material along the direction of transport, and a frequency of separation of the waste material (19) is greater than a frequency of discharge of the waste material (19).
